(19) United States
(12) Patent Application Publication
(10) Pub. No.: US 2006/0057541 A1
(43) Pub. Date: Mar. 16, 2006

(54) Tooth impressions, dental tray products and methods of manufacture and use

(76) Inventor: Joey Kahwaty, Renton, WA (US)

Correspondence Address: John P. Luther, Esq.;Newman & Newman LLP, Suite 610, 505 Fifth Avenue South, Seattle, WA, 98104, US

(21) Appl. No.: 10/941,255

(22) Filed: Sep. 14, 2004

(51) Int. Cl. A61C 5/00

(52) U.S. Cl. 433/215

(57) ABSTRACT

The present invention provides a novel dental tray for the application of dental-active and/or bio-active orally deployable substances to a user, and its method of fabrication comprising providing a first teeth conformable material effective to form dental impressions therein when applied to a user's teeth, and a second, separate and distinct conformable material effective to form dental impressions therein when applied to ma user's teeth, and which second conformable material is engaged and disposed over the first conformable material, and wherein the combination of said first and second conformable materials is deployed in a user's mouth such that when the user bites down and/or into the second conformable material a substantially complete impression of the user's teeth is created in the second conformable material as applied against and formed within the first conformable material, and when disengaged from the first conformable material the second conformable material comprising said impressions is effective to form a dental tray for the application of dental-active and/or bio-active orally deployable substances to the user.

### FIELD OF THE INVENTION

The present invention relates to teeth impressions and the manufacture of novel dental tray products useful for the application of teeth whitening and teeth desensitizing compositions, and the administration of other dental active and/or bio-active compounds and compositions, and further to product assemblies and product kit means comprising such products, methods for treating humans and animals with such products and kit means, and an array of methods for conducting business with the use of such products and kit means.

### BACKGROUND OF THE INVENTION

Copyright Notice 2004 Joey Kahwaty. A portion of the disclosure of this patent application/patent document contains material which is subject to copyright protection. The copyright owner has no objection to the facsimile reproduction by anyone of the patent document or the patent disclosure as it appears in the United States Patent and Trademark Office file or records.

Cosmetic dental whitening has become enormously popular in recent times, with the emergence of a bourgeoning industry producing a wide array of many useful and innovative products and methods. Traditionally, the majority of teeth whitening has been performed in dentists' offices involving relatively lengthy and costly procedures. Generally, a negative impression of a patient's teeth is first made in a dental office by a licensed or unlicensed professional by any of several available methods, such as by pressing a teeth conformable material, for example, an alginate composition, against the teeth which is then allowed to cure or harden into a permanent or semi-permanent impression which mimics the individual's teeth topography. The impressions, usually one for each of the upper and lower teeth, are oftentimes forwarded to a professional dental tray manufacturing facility where casts of the individual's teeth, such as a plaster or resin cast, are made up from the impressions, or such casts from impressions are made in the dental office. Next, whether in an outside facility or in a dental office, a cast conformable material, such as a thermoplastic elastomeric material, for example, ethylene vinyl acetate (EVA), is applied in relatively thin sheets over the teeth casts and vacuum formed thereon by the use of specialized machinery, such as Sta-Vac vacuum available from Buffalo Mfg. Co., or The Machine III, available from Keystone Industries. The elestomeric material is then allowed to cure and is separated from the teeth casts to provide custom made personalized teeth trays by way of the original impressions. The custom made trays are usually trimmed to some degree short of the gingival margin to prevent soft tissue irritation when such dental trays are used to apply a teeth whitening composition to the user's teeth. As can be readily seen, such a procedure can be very time consuming and labor intensive, and also fairly costly. To reiterate, a licensed or unlicensed dental professional must first take the upper and lower dental impressions of a patient's teeth in an initial appointment, which impressions must next be forwarded to a professional manufacturing facility for dental tray manufacture, or manufactured at the dental office, either way which necessitates the use of expensive specialized machinery. The patient must then attend one or more secondary appointments to determine if the dental trays fit properly, and if not to make the appropriate adjustments. In some whitening procedures, the dental office oftentimes may recommend that amount of dental work be undertaken, such as deep teeth cleaning, teeth restoration, teeth repair, fillings and the like, prior to dental whitening in an effort to maximize teeth whitening potential and to minimize teeth and gum sensitivity from whitening agents. Only then, after all of the above has been completed may the actual teeth whitening procedure commence. The entire ordeal often exceeds $1,000 in costs just for teeth impressions, tray manufacture and actual in-office whitening procedures, not to mention the costs of ancillary dental procedures, teeth cleaning etc.

As an alternative to such procedures, a sub-industry providing a variety of “do-it-yourself” or “at-home” dental whitening procedures and kits has emerged, which kits and procedures cost a fraction of traditional dental office teeth whitening activities, and without a patient having to undergo time consuming dental office appointments. Such procedures and attendant products usually entail the purchase of a generic “one-size-fits-all” mouthpiece or a dental products application tray for the self-administration of teeth whitening compositions and products by a user. Instructive of these products is the much used “boil-n-bite” system in which the user is provided a U-shaped conformable material having sides which enclose a cavity portion into which a user's teeth are inserted when biting down thereon. The material is first heated in boiling water or otherwise softened to a desired degree, with the user next inserting the product into her mouth with the user's teeth placed into the U-shaped cavity, and the user then bitting down to form, at most, crude teeth impressions or indentations in the softened material which somewhat mimic the user's teeth topography. Upper and lower teeth impressions are usually made. The material is then removed from the mouth and used as a self-made dental tray by filling same with a teeth whitening composition and applying the whole to surround the user's teeth to commence a teeth whitening process. Because such teeth whitening trays are not custom fitted and are only crude representations of an individual's teeth topography, it is oftentimes not possible, if not possible anytime, to obtain a tight, well fitting and comfortable mouthpiece or tray which securely fits onto a user's teeth, and which may be worn for extended periods without discomfort during teeth whitening sessions. Such trays also provide for less than optimal contact of a teeth whitening composition or other dental active substance with a user's teeth, resulting in unsatisfactory or incomplete whitening or other treatment, with a concomitant waste of materials and the need for frequent and uncomfortable repeated teeth whitening sessions in an attempt to achieve a desired whitening effect. Further, because of the bulky, unattractive nature of such self-made dental trays a user cannot really be expected to wear such trays in the public view, or even during sleep. Such trays are also known to inhibit speech of the user, further detracting from their desirability as long wearing teeth whitening or dental-active substance application trays.

Recently, a new generation of at-home or self-made teeth impression and/or dental tray fabricating materials and methods for the administration of teeth whitening compositions and other dental products has become available. In one example, as disclosed in U.S. patent application Ser. No. ______, filed ______, 2004, a method and set of materials is made available for a user to self-manufacture tight, well fitting, highly detailed negative teeth impressions outside of a dental office, such as in one's home or office or other convenient venue of choice. The self-made impressions are then mailed to a dental tray manufacture, usually in a pre-paid postage arrangement. The dental tray fabrication site may be a professional facility, or even an assembly line process for the economical fabrication of custom made and custom fitting dental trays from the self-made impressions by traditional cast making/vacuum forming methods using conformable material covering the casts such as EVA and trimming as necessary. The thus made trays, which are highly detailed to the individual user's teeth topography, are then returned to the user for the comfortable, efficient and highly effective self-application of teeth whitening compositions, teeth desensitizing compositions and other dental-active materials, such as remineralizing compounds and the like. A further advantage of such custom-made and fitted trays is that such are usually so well formed and transparent that they may be comfortably worn throughout a user's day, or evening, without notice from others, without inhibiting a user's speech, or even during sleep and all the while providing optimal teeth whitening and other treatments. The custom fitted trays are also used for the application of teeth desensitizing compositions to relieve teeth sensitivity which often accompanies teeth whitening. The materials for this method are conveniently provided in kit form, and optionally with an array of ancillary cosmetic dental materials, such as tooth paste, tooth brushes, and other dental active products including anti-decay products, teeth hardening and reminerlizing products, anti-demineralizing products, antibacterials, antibiotics, antifungals, anti-infectives, breath enhancing products, smoking desire inhibiting products, such as used in nicotine replacement thearpy, and other drug and bio-active compounds and compositions. Such products, methods and product assemblies or kits, or portions thereof, may be prescribed by a dental professional when required, or obtained directly from a mail order source for personal use.

In an effort to provide an even more economic and conveniently used system for at-home teeth whitening and optionally for the application of other dental-active products and other orally deployable substances, it would be beneficial to provide the user with an option to eliminate the requirements for outside casting and dental tray manufacture, and to still provide highly detailed, custom-conforming and fitting dental trays for teeth whitening, teeth desensitizing and the administration of other dental-active and bio-active products and the like.

### SUMMARY OF THE INVENTION

In accordance with the present invention there are provided novel dental whitening, dental/gum desensitizing and remineralizing methods and products, and methods for deploying and applying an array of dental active products and other bio-active products to a user. In its broadest aspect, the method entails the formation of one or more a dental trays for the application of dental-active and/or bio-active substances and orally deployable products to a user, which comprises providing a first teeth conformable material effective to form dental impressions therein when applied to a user's teeth, and a second, separate and distinct conformable material effective to form dental impressions therein when applied to a user's teeth, and which second material is engaged and disposed over the first conformable material, and the combination of said first and second conformable materials which is deployed in a user's mouth such that when the user bites down on the second conformable material a substantially complete impression of the user's teeth is created in the second material as applied against and formed within the first conformable material, and when disengaged from the first conformable material the second conformable material comprising said impressions is effective to form a dental tray for the application of dental-active and/or bio-active substances and/or orally deployable products to a user.

The invention is more fully understood with reference to the following Detailed Discussion of Preferred Embodiments with accompanying drawings.

### BRIEF DISCUSSION OF THE DRAWINGS

FIG. 1 illustrates a perspective view of a first conformable material as hand molded into a shape for use in the fabrication of dental trays of the invention.

FIG. 2 illustrates a perspective view of a second conformable material as applied to a first conformable material as shown in FIG. 1 in the fabrication of the dental trays of the invention.

FIG. 3 illustrates in perspective view the application of the combination of conformable materials shown in FIG. 2 as applied to a user's teeth in the fabrication of the dental trays of the invention.

FIG. 4 further illustrates in perspective view the application of the combination of conformable materials shown in FIG. 3 as applied to a user's teeth and the manufacture and formation of teeth impressions in a conformable material therein to thereby form the dental trays of the invention.

FIGS. 5 and 6 illustrate in perspective views dental trays manufactured in accordance with the invention, which may be trimmed according to a user's teeth topography and gingival margin for a custom fitting arrangement.

FIG. 7 illustrates in perspective view the application of a dental-active and/or bio-active substance to a dental tray manufactured in accordance with the invention.

FIG. 8 illustrates in perspective view the application of the inventive dental trays deploying and/or administering a dental-active and/or bio-active substance or other orally deployable substance to a user by way of application to the user's teeth.

### DETAILED DISCUSSION OF PREFERRED EMBODIMENTS

All patent references, published patent applications and literature references referred to or cited herein are expressly incorporated by reference to the same extent as if each were specifically and individually indicated to be incorporated by reference. Any inconsistency between these publications and the present disclosure is intended to and shall be resolved in favor of the present disclosure.

As set forth above, in its broadest sense the present invention provides novel methods and products for the delivery of dental-active and/or other bio-active substances to a user in need thereof or of desiring the use of such substances. In one aspect, the invention provides for the self-manufacture of highly detailed and personalized teeth conforming dental trays for the application of a variety of substances and products, such as teeth whitening compositions, teeth desensitizing compositions, teeth remineralizing and/or hardening products, teeth demineralizing inhibiting compounds, teeth decay inhibitors, breath enhancing compounds and products, antibacterial, anti-infective, antibiotic and antifungal compounds and compositions, and smoking desire inhibitors and the like. More particularly, in accordance with the present inventive method the formation and/or manufacture of one or more dental trays for the application of dental-active and/or bio-active and/or orally deployable substances to a user comprises providing a first conformable material effective to form dental impressions therein when applied to a user's teeth, and a second, separate and distinct conformable material effective to form dental impressions therein when applied to a user's teeth, and which second conformable material is engaged and disposed over the first conformable material, and the combination of said first and second conformable materials is deployed in a user's mouth such that when the user bites down on and/or into the second conformable material a substantially complete impression of the user's teeth is created, be it the upper or lower teeth, in the second conformable material as applied against and formed within the first conformable material, and when disengaged from the first conformable material, the second conformable material or sheet comprising said impressions is effective to form a dental tray for the application of dental-active and/or bio-active and/or any other orally deployable substances as desired to a user.

In preferred embodiments the first conformable material effective to form dental impressions when applied to a user's upper or lower teeth in conjunction with the second conformable material may be any known conventional material or substance (or non-conventional material or substance) suitable for use in such activity. Some non-limiting examples of such materials include organo polysiloxanes, such as polyvinyl siloxane, or silicone compression putty. Some particularly preferred materials are compositions manufactured from and/or comprising silicone oil and boric acid, one class of which is known as Silly Putty, and formally known as Dow Corning 3179 Dilatant Compound. This compound's composition is reported by weight percentage as follows: poly dimethyl siloxane (PDMS) 65%, silica 17%. thixotrol 9%, boric acid 4%, glycerine 1%, titanium dioxide 1%, and dimethyl cyclosiloxane 1%. Such material, known as a dilatant material, possesses unique properties and displays increased viscosity (resistance to flow) faster than the strain rate. In general, any teeth conformable compound, such as dilatant compounds and others effective to form teeth impressions therein and to preferably hold and maintain the shape of the impressions thus formed is suitable for use herein, and all substances which may be used in this invention are preferably nontoxic, and comply with local regulatory rules and regulations in the various jurisdictions of use, such as the United States Federal Drug and Food Administration (FDA).

Preferably, the first conformable material is employed in a mouth-sized fitting or palate-fitting slab of from at least in excess of the depth of a person's longest teeth, preferably to at least substantially cover a user's front seven or eight upper and/or lower teeth, and preferably even a bit thicker in order to effectively receive the entirety of and encapsulate the teeth impressions of the second conformable material as such are being made during teeth impression forming when a user bites into the second conformable material as applied to the first conformable material. In any event, such material may be employed in any size which fits in one's mouth, preferably in a comfortable arrangement, and provides effective support to receive and hold in place, or otherwise maintain the shape thereof, the dental impressions being formed, and formed, by the second conformable material therein when one is bitting down thereon or into same, and simultaneously in the first conformable material to which it is pressed against.

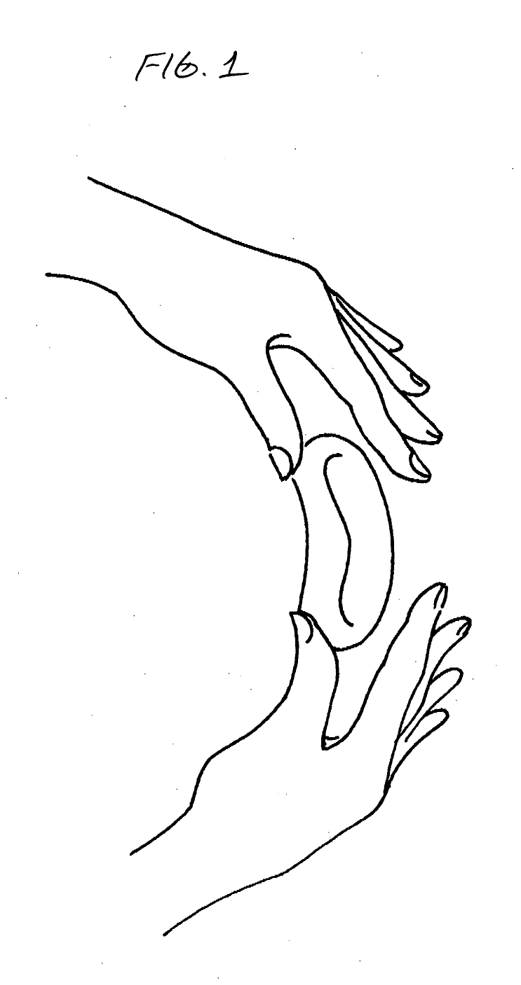

As shown in FIG. 1, the first conformable material can be conveniently shaped into a mouth cavity-fitting or palate-fitting slab in roughly the shape of a user's upper or lower teeth and/or biting configuration. This feature provides for one of the particular advantages of the invention over some home-forming dental tray techniques, which must deploy rigid, non-deformable mouthpieces into which deformable material is situated, and which may not always fit comfortably into a user's mouth or bite pattern, or conform comfortably to a user's palate.

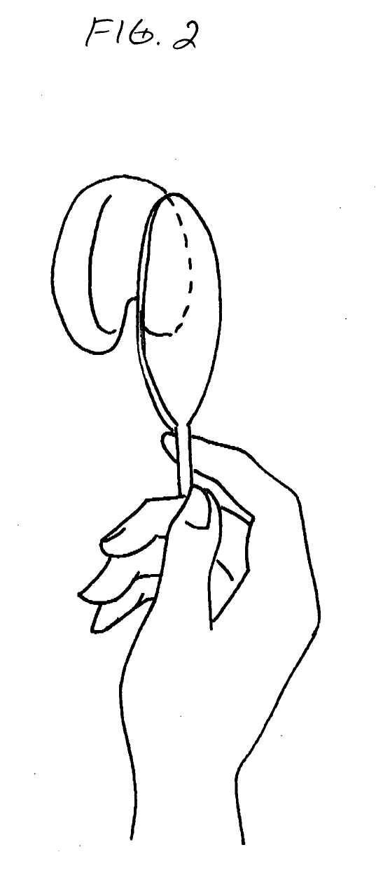

Next, as shown in FIG. 2, a second, separate and distinct sheet of conformable material effective to form dental impressions therein when applied to a user's teeth is engaged and disposed over the first conformable material, which, as discussed above, has been preferably shaped to fit a user's mouth cavity and/or upper or lower bite patterns, or generally a user's palate dimensions. The second conformable material is preferably used in relatively thin sheets with respect to the thickness of that used for the first conformable material, and may preferably be sized to be somewhat in excess of the surface area dimensions of the first conformable material as sized to fit a user's bite patterns so as to drape over its sides to be sure that sufficient material is present during the fabrication and formation of teeth impressions. Generally, however, the dimensions employed are approximately the size and shape of a user's palate. As also shown in FIG. 2, there may optionally be provided a handle or a holdable portion on this sheet of material to facilitate maneuvering, inserting, and removal of the second conformable material alone or in conjunction with or as applied to the first conformable material to and from a user's mouth cavity.

The second conformable material may be any conventional material (or unconventional material) useful in the formation of conventional dental trays, and may be, for example, a temperature and/or pressure deformable material, such as which is deformable into teeth impressions after immersion in hot water for a time, such as ethylene vinyl acetate (EVA), polyvinyl compounds, organopolysiloxanes, various plastics and/or other thermoplastic elastomeric materials and the like. Generally useful are any of those dental tray forming materials known to those skilled in the art. Again, it is of course preferable that such materials used herein are in compliance with local regulatory rules, regulations and other restrictions, if any, in the particular jurisdictions of use. The second conformable material may comprise the same material and dimensions thereof presently used for the professional manufacture of dental trays, which typically are of a very thin, lightweight, durable and transparent construction for ease and ability in forming detailed negative topological teeth facsimiles, and to substantially completely reproduce via impressions a user's teeth topography, and for ease and comfort in a user's daily (or nightly) wear and unobviousness to others of such use. In the present invention such materials may preferably be employed in thickness of up to about 0.05″.

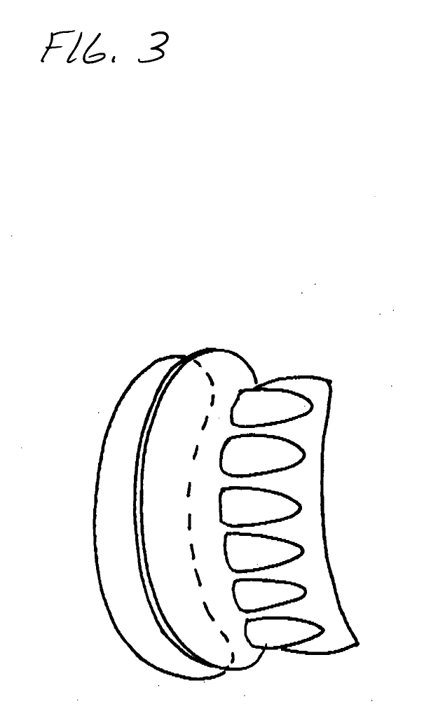

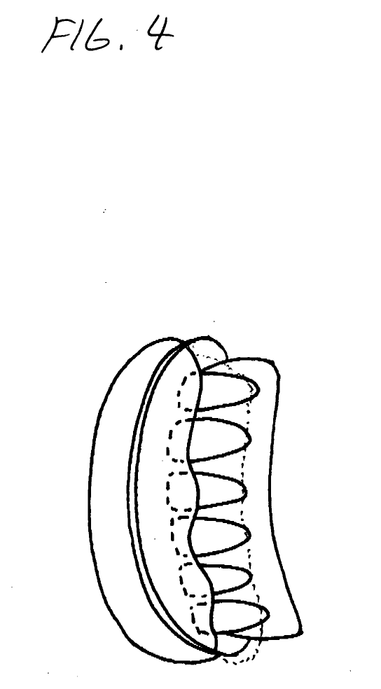

Referring now to FIGS. 3 and 4, in use a user will take a piece of the second conformable material and cut or trim it to a desired size relative to that of the first conformable material if necessary. The second conformable material may then be softened to a teeth impression making consistency or state by heating, for example, in water or by steaming, or by any other method for rendering said material to a teeth impression-making consistency if need be. Usually, for example, a desired temperature of water is reached, and the piece of second conformable material is immersed therein and allowed to soften, typically for a duration of from about 10 to about 40 seconds, depending on the nature of material employed, and for any time sufficient to render the material sufficiently pliable to form dental impressions in the sheet. Next, the softened second conformable sheet material is removed from the water and engaged with the piece of the first conformable material in a manner to preferably cover its entire surface area on one side thereof. When cool enough such as not to burn or harm oral tissue, the combination of first and second conformable materials is then placed into a user's mouth cavity, being careful that the second material is still in a sufficiently pliable state to form teeth impressions. The user then bites down onto and into the materials combination, preferably in a fashion such that the full length of the individual's teeth portions, preferable at least the front seven or eight upper and/or lower teeth, are immersed into the second conformable material as applied to the first conformable material to produce substantially identical user's negative teeth impressions therein, which are themselves reproduced as they are being made in the lower and now surrounding first conformable material, which acts as a support member or tray during such process. Depending on which side of the first conformable material the second conformable material has been placed, one's upper or lower teeth impression will be produced in the combination of materials.

Preferably, the combination of first and second conformable materials is present in an amount and shape to be in contact with at least a majority of the teeth undergoing impression taking, be it upper or lower teeth, notwithstanding the absence of one or more teeth in various locations, and said combination is held in position as applied to the user's teeth in a steady fashion and for a duration such that a precise and substantially complete dental impression of the user's teeth topography is made when the user bites into the combination of materials. While biting against the combination of materials, the user may preferably use her fingers to push a portion of the first conformable material against the juxtaposed second conformable material in contact with the user's teeth, and thus against the teeth portions undergoing impression making, and perhaps gum portions of the user, to insure the substantially complete immersion of the user's teeth into the materials combination, and/or to insure correct positioning and the like, such as depicted by the cut-away line in FIG. 4, and to thus insure complete and consistent teeth whitening composition application when so employed as situated between a user's teeth and a substantially complete negative reproduction of said teeth comprising the inventive dental trays, and/or the complete and consistent application of other dental-active compositions and orally deployable products as desired, or to insure the production of a dental tray which completely covers and guards the teeth in other aspects of the invention, as more fully discussed below.

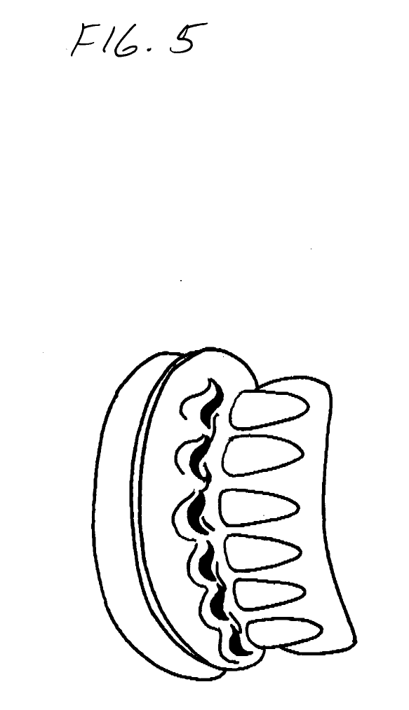

Referring now to FIG. 5, after the user has bitten into the first and second conformable materials combination, preferably in the manner described above, and has held a firm position for a desired time, such as for, say, 5 to 15 seconds, or until an accurate and substantially complete, and preferably substantially durable, dental impression of the user's teeth portion has been produced, the combination comprising the thus formed teeth impressions is dislodged and removed from the user's teeth and mouth. Preferably, because only the second conformable material has been in contact with the user, it may be removed relatively easily.

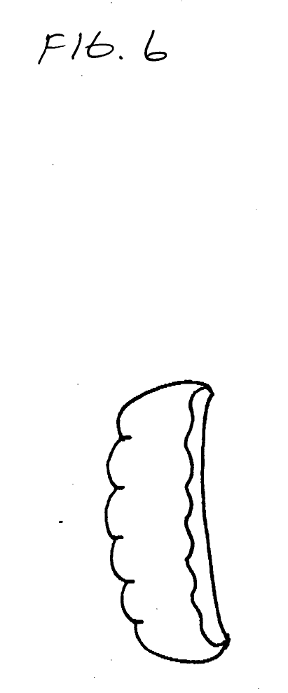

FIG. 6 illustrates a thus formed durable dental product comprising the second conformable material with teeth impressions formed therein (an upper teeth portion) now defining the dental tray after it has been removed from the first conformable material, which is usually easily accomplished due to the nature of preferred silicone-based materials which may be employed herein. In accordance with the present invention, the produced dental tray impression(s), because of its direct fabrication from contact with a user's teeth in one step, now substantially completely mimics in high detail and definition a substantially identical reproduction or facsimile of the user's teeth topography, and provides for a superior performing dental-active substance and other orally deployable product application device with aesthetically pleasing appearances, and which is also uncomparable in its comfortable, form fitting nature. Any excess material which may surround the edges of the fabricated inventive dental trays can now be simply trimmed away as desired, while being careful not to cut into operative portions of the trays.

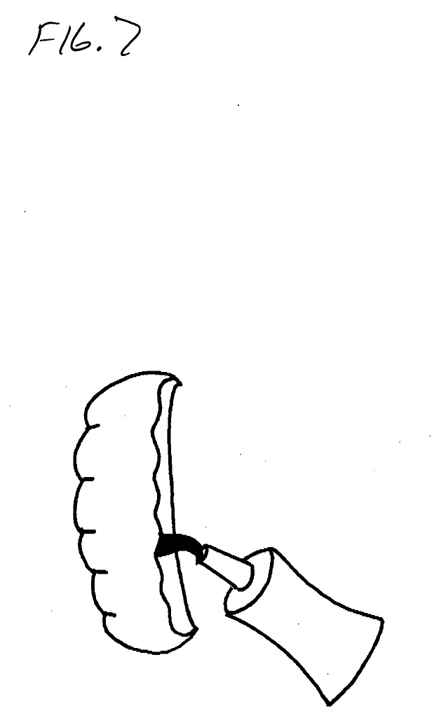

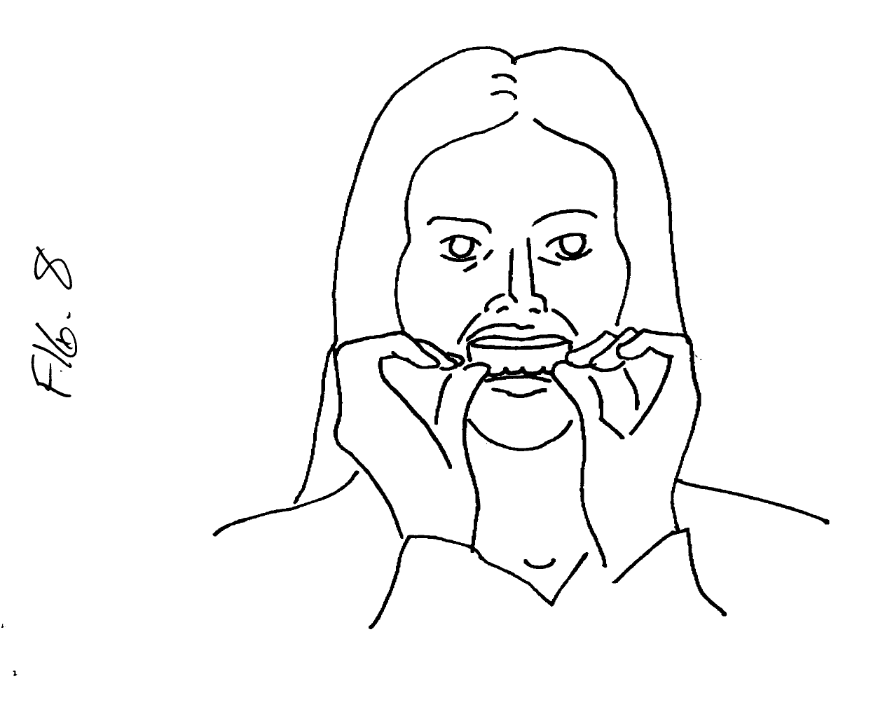

As shown in FIG. 7 a dental-active substance or product or other orally deployable bio-active substance or product useful for any efficacy as desired may be conveniently applied to an inventive dental tray such as manufactured and/or fabricated in a manner as described above for the administration thereof to a user in need or desire thereof. For example, a teeth whitening composition, such as a carbamide peroxide-based gel, or a teeth desensitizing composition, such as a potassium nitrate-based composition in gel form, as disclosed, for example, in co-pending U.S. patent application Ser. No. ______, filed ______, may be applied to the inventive dental trays and employed in superior at-home or do-it-yourself teeth whitening and/or teeth desensitizing sessions. Additionally, an array of dental active compounds and compositions and/or bio-active substances or any other orally deployable substances displaying any efficacy as desired, adjuvants and excipients may be used in conjunction with such teeth whitening and/or desensitizing methods, or by themselves for their convenient and efficient delivery and administration. Some non-limiting examples include pharmaceuticals; neutraceuticals; nutrients; food supplements; smoking desire inhibiting compounds and compositions such as used in nicotine replacement therapy, and other smoking desire inhibiting compounds such as welbutrin; alcohol desire inhibiting compositions, such as naltrexone and naloxone; cholesterol lowering compounds, such as a member of the statin family, for example, lipitor; antibacterials, antibiotics; antifungals; anti-infectives; antacids; and breath enhancing compounds. Such compounds and compositions and methods of administration are discussed in detail in co-pending U.S. patent application Ser. No. ______, filed on ______, 2004, which is expressly incorporated herein by reference. As shown in FIG. 8 a user may conveniently apply and/or orally administer any of such substances and/or compounds as above-described by way of the inventive dental trays.

The materials for the self-fabrication or manufacture of the inventive dental trays may be conveniently provided to a user in kit form or means, optionally along with materials for teeth whitening, teeth desensitizing, and/or teeth remineralizing and the like, and preferably including a set of detailed instructions for use, all or portions of which may be obtained from a regulated source upon receiving a prescription from a licensed dental professional if so required in a particular jurisdiction, or obtained directly from a mail order source. A wide array of ancillary teeth whitening/teeth desensitizing materials is also contemplated for inclusion in kit form, such as tooth paste, which may have whitening efficacy characteristics, tooth brushes, dental floss, breath enhancing compounds and teeth care/teeth cosmetics literature and the like.

In yet another aspect of the invention, the inventive dental trays and their manufacture may be employed in the production of conveniently available, and superior fitting teeth guards for use in a variety of activities ranging from physical contact sports to guards to be worn during sleep to prevent potentially damaging teeth grinding and wear, or otherwise to successfully protect a user's teeth from bruxism. Depending upon the end use contemplated, the second conformable material used in the materials combination to fabricate the dental trays of the invention may be provided in any desired thickness as the activity and degree of dental protection necessitates.

In further aspects of the invention, the unique advantages afforded by the inventive dental tray products, their methods of fabrication, and methods for administering and/or application of teeth whitening compositions, teeth desensitizing compositions and a vast array of other dental- and bio-active products thereby, and the inventive kit assemblies comprising same provide for unique and heretofore unavailable advantages in conducting a wide array of business functions, including the design, manufacture, use, marketing, sale, leasing and licensing of such products and methods and associated or ancillary materials, such as toothbrushes, toothpaste, dental floss and the like. Other advantages are afforded by the inventive products and methods by their use in generating business good will, in the generation of valuable trademark rights as source identifiers of the unique inventive products and methods, and novel and unique material and subject matter for the creation and operation of new business entities, and various joint venture endeavors and collaborations.

This invention has been described in conjunction with illustrative examples of some preferred embodiments, but it is not to be construed to be so limited as one skilled in the art will be able to utilize and employ substitutes and equivalents thereof without departing from the scope and bounds of the invention and the spirit thereof.

What is claimed is:

1. A method for the fabrication of dental trays for use in the application of dental-active compositions and/or orally deployable bio-active compounds and compositions to human and animals in need or desire thereof, comprising providing a first teeth conformable material effective to form dental impressions therein when applied to a user's teeth, and a second separate and distinct conformable material effective to form teeth impressions therein when applied to a user's teeth, and wherein the second conformable material is engaged and disposed over the first conformable material, and deploying the combination of said first and second conformable materials in a user's mouth such that when the user bites down on the second conformable material, a substantially complete impression of the user's teeth is created in the second conformable material as applied against and formed within the first conformable material, and then disengaging the first conformable material from the second conformable material comprising the user's dental impressions, and wherein said teeth impression comprising second conformable material is effective for use as said dental tray.

2. The method of claim 1 wherein said thus formed dental tray is durable.

3. The method of claim 1 wherein said first conformable material is a polymeric composition comprising an organo-silicone compound and boric acid.

4. The method of claim 1 wherein said second conformable material is ethylene vinyl acetate, and is rendered sufficiently pliable to form teeth impressions prior to oral deployment in conjunction with the first conformable material.

5. The method of claim 1 wherein said second conformable material is present in a sheet form and is relatively thin compared to the first conformable material.

6. The method of claim 1 wherein said dental tray is further effective to prevent bruxism when applied to a user.

7. The method of claim 1 wherein said dental tray is an effective athletic teeth guard when applied to a user.

8. The method of claim 1 wherein said dental tray is effective to apply and/or administer a teeth whitening compound or composition to a user.

9. The method of claim 1 wherein said dental tray is effective to apply and/or administer a teeth desensitizing compound or composition to a user.

10. The method of claim 1 wherein said dental tray is effective to apply and/or administer a teeth re-mineralizing compound or composition to a user.

11. The method of claim 1 wherein said dental tray is effective to apply and/or administer a compound or composition to a user selected from teeth decay inhibiting agents, antibiotics, antibacterials, antifungals, antiinfectives, smoking sesire inhibiting agents, alcohol consumption desire inhibiting agents, alcohol consumption desire inhibiting agents, pharmaceuticals, nutrients, food supplements, neutraceuticals, and breath enhancing agents.

12. A kit means comprising materials for carrying out the method of claim 1.

13. The kit means of claim 12 further comprising a dental active and/or bio-active orally deployable substance.

14. The kit means of claim 13 wherein said substance comprises a compound or composition selected from the group consisting of teeth whitening agents, teeth desensitizing agents, teeth re-mineralizing agents, teeth decay inhibiting agents, antibacterials, antibiotics, antifungals, antiinfectives, smoking desire inhibiting agents, alcohol consumption desire inhibiting agents, pharmaceuticals, neutriceuticals, nutrients, food supplements, and breath enhancers.

15. A dental product produced by the method of claim 1.

16. A dental product produced by the method of claim 2.

17. A dental product produced by the method of claim 13.

18. A dental product produced by the method of claim 4.

19. A dental product produced by the method of claim 5.

20. A dental product produced by the method of claim 6.

21. A dental product produced by the method of claim 7.

22. A dental product produced by the method of claim 8.

23. A dental product produced by the method of claim 9.

24. A dental product produced by the method of claim 10.

25. A dental product produced by the method of claim 11.

26. A method of treating a human or animal in need thereof comprising the use of the dental product of claim 15.

27. A method of treating a human or animal in need thereof comprising the use of the dental product of claim 16.

28. A method of treating a human or animal in need thereof comprising the use of the dental product of claim 17.

29. A method of treating a human or animal in need thereof comprising the use of the dental product of claim 18.

30. A method of treating a human or animal in need thereof comprising the use of the dental product of claim 19.

31. A method of treating a human or animal in need thereof comprising the use of the dental product of claim 20.

32. A method of treating a human or animal in need thereof comprising the use of the dental product of claim 21.

33. A method of treating a human or animal in need thereof comprising the use of the dental product of claim 22.

34. A method of treating a human or animal in need thereof comprising the use of the dental product of claim 23.

35. A method of treating a human or animal in need thereof comprising the use of the dental product of claim 24.

36. A method of treating a human or animal in need thereof comprising the use of the dental product of claim 25.

37. A method of treating a human or animal in need thereof comprising the use of the kit means of claim 12.

38. A method of treating a human or animal in need thereof comprising the use of the kit means of claim 13.

39. A method of treating a human or animal in need thereof comprising the use of the kit means of claim 14.

40. A method of conducting a business function selected from designing, manufacturing, using, marketing, distributing, selling, licensing, leasing, forming and operating a business entity generating business goodwill and/or generating trademark rights comprising the use of method of claim 1.

41. A method of conducting a business function selected from designing, manufacturing, using, marketing, distributing, selling, licensing, leasing and forming and operating a business entity generating business goodwill and/or generating trademark rights comprising the use of the method of claim 2.

42. A method of conducting a business function selected from designing, manufacturing, using, marketing, distributing, selling, licensing, leasing and forming and operating a business entity generating business goodwill and/or generating trademark rights comprising the use of the method of claim 3.

43. A method of conducting a business function selected from designing, manufacturing, using, marketing, distributing, selling, licensing, leasing and forming and operating a business entity generating business goodwill and/or generating trademark rights comprising the use of the method of claim 4.

44. A method of conducting a business function selected from designing, manufacturing, using, marketing, distributing, selling, licensing, leasing and forming and operating a business entity generating business goodwill and/or generating trademark rights comprising the use of the method of claim 5.

45. A method of conducting a business function selected from designing, manufacturing, using, marketing, distributing, selling, licensing, leasing and forming and operating a business entity generating business goodwill and/or generating trademark rights comprising the use of the method of claim 6.

46. A method of conducting a business function selected from designing, manufacturing, using, marketing, distributing, selling, licensing, leasing and forming and operating a business entity generating business goodwill and/or generating trademark rights comprising the use of the method of claim 7.

47. A method of conducting a business function selected from designing, manufacturing, using, marketing, distributing, selling, licensing, leasing and forming and operating a business entity generating business goodwill and/or generating trademark rights comprising the use of the method of claim 8.

48. A method of conducting a business function selected from designing, manufacturing, using, marketing, distributing, selling, licensing, leasing and forming and operating a business entity generating business goodwill and/or generating trademark rights comprising the use of the method of claim 9.

49. A method of conducting a business function selected from designing, manufacturing, using, marketing, distributing, selling, licensing, leasing and forming and operating a business entity generating business goodwill and/or generating trademark rights comprising the use of the method of claim 10.

50. A method of conducting a business function selected from designing, manufacturing, using, marketing, distributing, selling, licensing, leasing and forming and operating a business entity generating business goodwill and/or generating trademark rights comprising the use of the method of claim 11.

51. A method of conducting a business function selected from designing, manufacturing, using, marketing, distributing, selling, licensing, leasing and forming and operating a business entity generating business goodwill and/or generating trademark rights comprising the use of the method of the kit means of claim 12.

52. A method of conducting a business function selected from designing, manufacturing, using, marketing, distributing, selling, licensing, leasing and forming and operating a business entity generating business goodwill and/or generating trademark rights comprising the use of the method of the kit means of claim 13.

53. A method of conducting a business function selected from designing, manufacturing, using, marketing, distributing, selling, licensing, leasing and forming and operating a business entity generating business goodwill and/or generating trademark rights comprising the use of the method of the kit means of claim 14.

54. A method of conducting a business function selected from designing, manufacturing, using, marketing, distributing, selling, licensing, leasing and forming and operating a business entity generating business goodwill and/or generating trademark rights comprising the use of the dental product of claim 15.

55. A method of conducting a business function selected from designing, manufacturing, using, marketing, distributing, selling, licensing, leasing and forming and operating a business entity generating business goodwill and/or generating trademark rights comprising the use of the dental product of claim 16.

56. A method of conducting a business function selected from designing, manufacturing, using, marketing, distributing, selling, licensing, leasing and forming and operating a business entity generating business goodwill and/or generating trademark rights comprising the use of the dental product of claim 17.

57. A method of conducting a business function selected from designing, manufacturing, using, marketing, distributing, selling, licensing, leasing and forming and operating a business entity generating business goodwill and/or generating trademark rights comprising the use of the dental product of claim 18.

58. A method of conducting a business function selected from designing, manufacturing, using, marketing, distributing, selling, licensing, leasing and forming and operating a business entity generating business goodwill and/or generating trademark rights comprising the use of the dental product of claim 19.

59. A method of conducting a business function selected from designing, manufacturing, using, marketing, distributing, selling, licensing, leasing and forming and operating a business entity generating business goodwill and/or generating trademark rights comprising the use of the dental product of claim 20.

60. A method of conducting a business function selected from designing, manufacturing, using, marketing, distributing, selling, licensing, leasing and forming and operating a business entity generating business goodwill and/or generating trademark rights comprising the use of the dental product of claim 21.

61. A method of conducting a business function selected from designing, manufacturing, using, marketing, distributing, selling, licensing, leasing and forming and operating a business entity generating business goodwill and/or generating trademark rights comprising the use of the dental product of claim 22.

62. A method of conducting a business function selected from designing, manufacturing, using, marketing, distributing, selling, licensing, leasing and forming and operating a business entity generating business goodwill and/or generating trademark rights comprising the use of the dental product of claim 23.

63. A method of conducting a business function selected from designing, manufacturing, using, marketing, distributing, selling, licensing, leasing and forming and operating a business entity generating business goodwill and/or generating trademark rights comprising the use of the dental product of claim 24.

64. A method of conducting a business function selected from designing, manufacturing, using, marketing, distributing, selling, licensing, leasing and forming and operating a business entity generating business goodwill and/or generating trademark rights comprising the use of the dental product of claim 25.

65. A method of conducting a business function selected from designing, manufacturing, using, marketing, distributing, selling, licensing, leasing and forming and operating a business entity generating business goodwill and/or generating trademark rights comprising the use of the method of claim 26.

66. A method of conducting a business function selected from designing, manufacturing, using, marketing, distributing, selling, licensing, leasing and forming and operating a business entity generating business goodwill and/or generating trademark rights comprising the use of the method of claim 27.

67. A method of conducting a business function selected from designing, manufacturing, using, marketing, distributing, selling, licensing, leasing and forming and operating a business entity generating business goodwill and/or generating trademark rights comprising the use of the method of claim 28.

68. A method of conducting a business function selected from designing, manufacturing, using, marketing, distributing, selling, licensing, leasing and forming and operating a business entity generating business goodwill and/or generating trademark rights comprising the use of the method of claim 29.

69. A method of conducting a business function selected from designing, manufacturing, using, marketing, distributing, selling, licensing, leasing and forming and operating a business entity generating business goodwill and/or generating trademark rights comprising the use of the method of claim 30.

70. A method of conducting a business function selected from designing, manufacturing, using, marketing, distributing, selling, licensing, leasing and forming and operating a business entity generating business goodwill and/or generating trademark rights comprising the use of the method of claim 31.

71. A method of conducting a business function selected from designing, manufacturing, using, marketing, distributing, selling, licensing, leasing and forming and operating a business entity generating business goodwill and/or generating trademark rights comprising the use of the method of claim 32.

72. A method of conducting a business function selected from designing, manufacturing, using, marketing, distributing, selling, licensing, leasing and forming and operating a business entity generating business goodwill and/or generating trademark rights comprising the use of the method of claim 33.

73. A method of conducting a business function selected from designing, manufacturing, using, marketing, distributing, selling, licensing, leasing and forming and operating a business entity generating business goodwill and/or generating trademark rights comprising the use of the method of claim 34.

74. A method of conducting a business function selected from designing, manufacturing, using, marketing, distributing, selling, licensing, leasing and forming and operating a business entity generating business goodwill and/or generating trademark rights comprising the use of the method of claim 35.

75. A method of conducting a business function selected from designing, manufacturing, using, marketing, distributing, selling, licensing, leasing and forming and operating a business entity generating business goodwill and/or generating trademark rights comprising the use of the method of claim 36.

76. A method of conducting a business function selected from designing, manufacturing, using, marketing, distributing, selling, licensing, leasing and forming and operating a business entity generating business goodwill and/or generating trademark rights comprising the use of the method of claim 37.

77. A method of conducting a business function selected from designing, manufacturing, using, marketing, distributing, selling, licensing, leasing and forming and operating a business entity generating business goodwill and/or generating trademark rights comprising the use of the method of claim 38.

78. A method of conducting a business function selected from designing, manufacturing, using, marketing, distributing, selling, licensing, leasing and forming and operating a business entity generating business goodwill and/or generating trademark rights comprising the use of the method of claim 39.
